(19) United States
(12) Patent Application Publication
(10) Pub. No.: US 2017/0162221 A1
(43) Pub. Date: Jun. 8, 2017

(54) Optical Information Recording/Reproduction Device and Optical Information Recording/Reproduction Method

(71) Applicant: Hitachi Consumer Electronics Co., Ltd., Yokohama-shi, Kanagawa (JP)

(72) Inventor: Masanobu SHIGAKI, Tokyo (JP)

(21) Appl. No.: 15/320,766

(22) PCT Filed: Jun. 25, 2014
(86) PCT No.: PCT/JP2014/066761

§ 371 Date: Dec. 21, 2016

(51) Int. Cl. G11B 7/0065; G11B 7/135; G11B 7/0045; G03H 1/26

(52) U.S. Cl. CPC G11B 7/0065; G03H 1/26; G11B 7/135; G11B 7/0045; G03H 2001/2605; G11B 2007/00653; G11B 2007/00656

(57) ABSTRACT

Provided is a recording method with which wasteful consumption of the M number (M/#) of the recording material is prevented, and with which the recording density is improved. An optical information recording device that utilizes interference between signal light and reference light to record information on an optical information recording medium is equipped with: a light source that emits light toward an optical recording medium; a beam-splitting element that splits the emission light emitted from the light source into signal light and reference light; and a reference light angle control unit that controls the incidence angle of the reference light with respect to the optical information recording medium. The optical recording medium is irradiated with the signal light as a spherical wave and is irradiated with the reference light as a planar wave, and when information is recorded on the optical information recording medium, the optical information recording medium is irradiated such that there exists in the interior of the optical information recording medium a region which is exposed only to the signal light, a region which is exposed only to the reference light, and a region which is exposed to overlapping signal light and reference light.

### TECHNICAL FIELD

The present invention relates to a technique of recording/reproducing information on/from an optical information recording medium.

### BACKGROUND ART

When a plurality of angle-multiplexed holograms are arranged and recorded on a recording medium, it is generally necessary to reduce a distance between neighboring holograms to improve a recording density. A method has been proposed so far in Patent Literature 1 in which signal light having information on page data is condensed, an opening is formed at a beam waist of the signal light to remove a high-frequency component and holograms are recorded with the distance between neighboring holograms reduced.

Patent Literature 2 describes that “when an angle of scanning mirror 12 is changed to cause an angle of incidence of reference light 200 incident upon hologram recording material 15 to change, an angle of slit 11 is also changed together and a beam diameter of reference light 200 is thereby changed by slit 11 so that an irradiation range on hologram recording material 15 is not changed due to a change in the angle of incidence of reference light 200 but fixed. This, even when the angle of incidence of reference light 200 is changed during hologram recording under an angle-multiplexed recording scheme, it is possible to always keep constant the area of hologram material 15 irradiated with reference light 200.”

### CITATION LIST

Patent Literature 1: JP-A-2004-272268
Patent Literature 2: JP-A-2006-23445

### SUMMARY OF INVENTION

### Technical Problem

When improving a hologram recording density using the method described in Patent Literature 1, it is possible to reduce the distance between neighboring holograms down to the size of an opening at a beam waist of the signal light at a minimum. On the other hand, as described in Patent Literature 2, it is considered preferable to record holograms by causing all signal light beams that pass through a recording medium to overlap with reference light as a condition for recording holograms with stable reproduction quality.

The method according to Patent Literature 1 has a feature that signal light is condensed by a lens as a spherical wave and a recording medium is irradiated with the reference light as a planar wave. Thus, when holograms are recorded by causing all signal light beams passing through the recording medium to overlap with reference light, there exists a region where the recording medium is irradiated with only the reference light during hologram recording in a recording region in the vicinity of the beam waist part of the signal light. In the region where the recording medium is irradiated with only the reference light, there is a problem that a dynamic range of the recording material is wastefully consumed and the number of holograms that can be multiplexed in the recording region adjacent to the beam waist of the signal light decreases. Note that the “dynamic range” of the recording material refers to an index that indicates multiplex recording performance of a hologram, which is hereinafter referred to as “M/# (M number).” The “beam waist” refers to a region where a beam is condensed by an optical element such as a lens and the size of the condensed spot becomes minimum.

It is therefore an object of the present invention to provide a recording method that improves a hologram recording density.

### Solution to Problem

As means for solving the above-described problem, for example, a configuration described in the scope of claims for patent may be adopted. One such example is an optical information recording device that records information on an optical information recording medium using interference between signal light and reference light, the optical information recording device including a light source that emits light toward the optical information recording medium, a beam-splitting element that splits the emission light emitted from the light source into the signal light and the reference light, and a reference light angle control unit that controls an angle of incidence of the reference light with respect to the optical information recording medium in which the optical information recording medium is irradiated with the signal light as a spherical wave and is irradiated with the reference light as a planar wave and when information is recorded on the optical information recording medium, the optical information recording medium is irradiated such that there exist in the interior of the optical information recording medium a region which is exposed only to the signal light, a region which is exposed only to the reference light, and a region which is exposed to overlapping signal light and reference light.

### Advantageous Effects of Invention

The present invention can provide a technique of recording information on an optical information recording medium at a high density.

### BRIEF DESCRIPTION OF DRAWINGS

FIG. 1 is a block diagram illustrating an embodiment of an optical information recording/reproduction device.

FIG. 2 is a schematic diagram illustrating an embodiment of a pickup in the optical information recording/reproduction device.

FIG. 3 is a schematic diagram illustrating an embodiment of a pickup in the optical information recording/reproduction device.

FIG. 4(a) is a schematic diagram illustrating an embodiment of an operation flow after insertion of an optical information recording medium until recording or reproduction of the optical information recording/reproduction device.

FIG. 4(b) is a schematic diagram illustrating an embodiment of an operation flow of recording information of the optical information recording/reproduction device.

FIG. 4(c) is a schematic diagram illustrating an embodiment of an operation flow of reproducing information of the optical information recording/reproduction device.

FIG. 5 is a schematic diagram illustrating an optical information recording medium, signal light and reference light during recording of an angle-multiplexed hologram.

FIG. 6(a) is a schematic diagram illustrating a conventional recording method for the optical information recording medium.

FIG. 6(b) is a schematic diagram illustrating a region where the optical information recording medium is irradiated with only reference light according to the conventional recording method.

FIG. 6(c) is a schematic diagram illustrating the optical information recording medium whose recording density is improved using the conventional recording method.

FIG. 7(a) is a schematic diagram of a pitch direction representing a recording method according to one embodiment of the present invention.

FIG. 7(b) is a schematic diagram of a pitch direction representing a region where the optical information recording medium is irradiated with only reference light using the recording method according to the one embodiment of the present invention.

FIG. 7(c) is a schematic diagram of a pitch direction showing the recording density improved using the recording method according to the one embodiment of the present invention.

FIG. 8 is a schematic diagram illustrating a method of reproducing information from the optical information recording medium.

FIG. 9(a) is a schematic diagram of a Bragg direction illustrating the recording method according to the one embodiment of the present invention.

FIG. 9(b) is a schematic diagram illustrating a Bragg direction showing a region where the optical information recording medium is irradiated with only reference light using the recording method according to the one embodiment of the present invention.

FIG. 9(c) is a schematic diagram illustrating a Bragg direction showing the recording density improved using the recording method according to the one embodiment of the present invention.

FIG. 10 is a schematic diagram illustrating a second embodiment of the pickup in the optical information recording/reproduction device.

FIG. 11 is a schematic diagram illustrating a relationship between an angle of reference light and a change rate of beam diameter of reference light.

FIG. 12 is a flowchart of executing a book recording process according to the embodiment of the present invention.

FIG. 13(a) is a schematic diagram illustrating a relationship between an amount of shift of a recording medium and an angle of reference light for recording pages.

FIG. 13(b) is a schematic diagram illustrating an example of a relationship between an amount of shift of a recording medium and an angle of reference light for recording pages.

FIG. 14 is a schematic diagram illustrating another example showing a relationship between an angle of reference light and a beam diameter change rate of reference light.

FIG. 15 is a schematic diagram illustrating a method of reproducing information from the optical information recording medium.

FIG. 16 is a flowchart of executing a book reproduction process according to the one embodiment of the present invention.

FIG. 17 is a diagram illustrating a relationship between an angle of incidence of reference light and an amount of light received by a photodetector according to the one embodiment of the present invention.

FIG. 18 is a diagram illustrating a relationship between signal amplitude and noise amplitude according to the one embodiment of the present invention.

FIG. 19 is a flowchart of reproduction operation for optionally controlling a beam diameter of reference light according to the one embodiment of the present invention.

### DESCRIPTION OF EMBODIMENTS

Hereinafter, embodiments of the present invention will be described with reference to the accompanying drawings.

### Embodiment 1

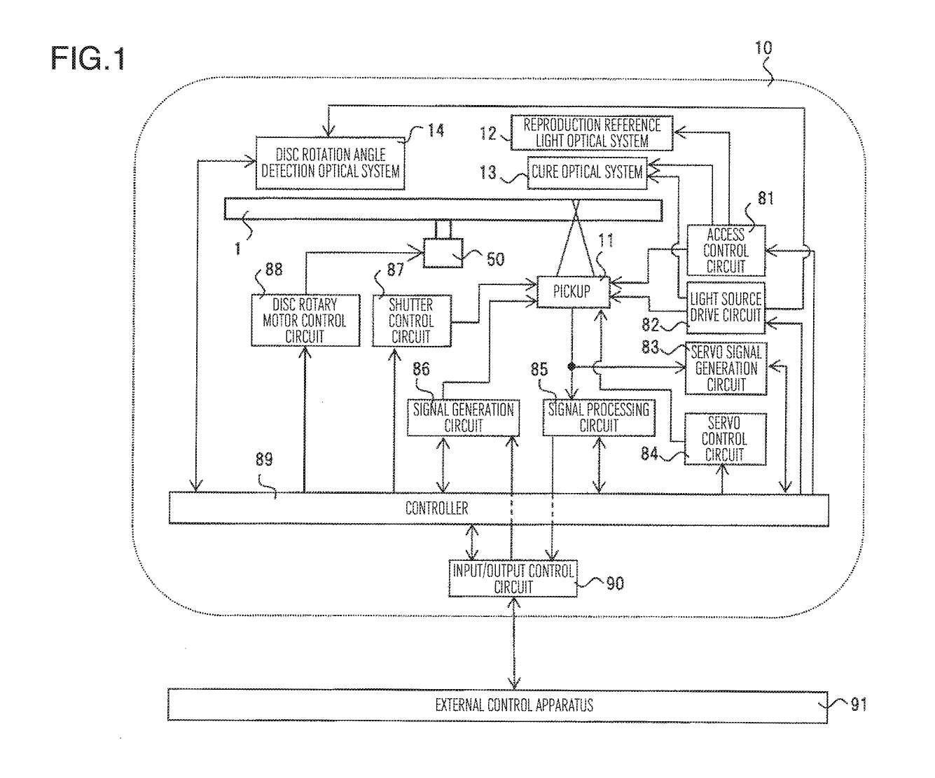

An embodiment of the present invention is described according to the accompanying drawings. FIG. 1 is a block diagram illustrating a recording/reproduction device for an optical information recording medium that records and/or reproduces digital information using holography.

Optical information recording/reproduction device 10 is connected to external control apparatus 91 via input/output control circuit 90. When performing recording, optical information recording/reproduction device 10 receives an information signal to be recorded from external control apparatus 91 via input/output control circuit 90. When performing reproduction, optical information recording/reproduction device 10 transmits the reproduced information signal to external control apparatus 91 via input/output control circuit 90.

Optical information recording/reproduction device 10 is provided with pickup 11, reproduction reference light optical system 12, cure optical system 13, disc rotation angle detection optical system 14 and rotary motor 50, and optical information recording medium 1 is configured to be rotatable by rotary motor 50.

Pickup 11 emits reference light and signal light toward optical information recording medium 1 and plays a role of recording digital information on a recording medium using holography. In this case, an information signal to be recorded is sent by controller 89 to a spatial optical modulator in pickup 11 via signal generation circuit 86 and the signal light is modulated by the spatial optical modulator.

When reproducing the information recorded on optical information recording medium 1, reproduction reference light optical system 12 generates an optical wave to be made incident upon the optical information recording medium in a direction opposite to a direction when reference light emitted from pickup 11 is recorded. A photodetector in pickup 11, which will be described later, detects the reproduced light reproduced by reproduction reference light and signal processing circuit 85 reproduces the signal.

An irradiation time during which optical information recording medium 1 is irradiated with reference light or signal light can be adjusted by controller 89 controlling an opening-closing time of a shutter in pickup 11 via shutter control circuit 87.

Cure optical system 13 plays a role of generating light beams used for pre-curing and post-curing of optical information recording medium 1. “Pre-curing” is a pre-process of irradiating optical information recording medium 1 with a predetermined light beam in advance before irradiating it with reference light and signal light at desired positions when information is recorded at the desired positions in optical information recording medium 1. “Post-curing” is a post-process of irradiating optical information recording medium 1 with a predetermined light beam for disabling additional writing at the desired positions after information is recorded at the desired positions in optical information recording medium 1.

Disc rotation angle detection optical system 14 is used to detect an angle of rotation of optical information recording medium 1. When optical information recording medium 1 is adjusted to a predetermined angle of rotation, disc rotation angle detection optical system 14 can detect a signal corresponding to the angle of rotation and controller 89 can control the angle of rotation of optical information recording medium 1 via disc rotary motor control circuit 88 using the detected signal.

A predetermined light source drive current is supplied from light source drive circuit 82 to pickup 11, cure optical system 13 and the light source in disc rotation angle detection optical system 14 and a light beam can be emitted from each light source with a predetermined light quantity.

Pickup 11 and disc cure optical system 13 are provided with a mechanism whereby their positions can be slid in a radius direction of optical information recording medium 1 and position control is performed via access control circuit 81.

The recording technique utilizing a principle of angle multiplexing of holography has a tendency that its allowance for deviation of an angle of reference light decreases extremely.

Therefore, it is necessary to provide a mechanism to detect an amount of deviation in the angle of reference light in pickup 11, cause servo signal generation circuit 83 to generate a servo control signal and provide a servo mechanism to correct the amount of deviation in optical information recording/reproduction device 10 via servo control circuit 84.

Furthermore, pickup 11, cure optical system 13 and disc rotation angle detection optical system 14 may be simplified by bringing together several optical system configurations or all optical system configurations into one.

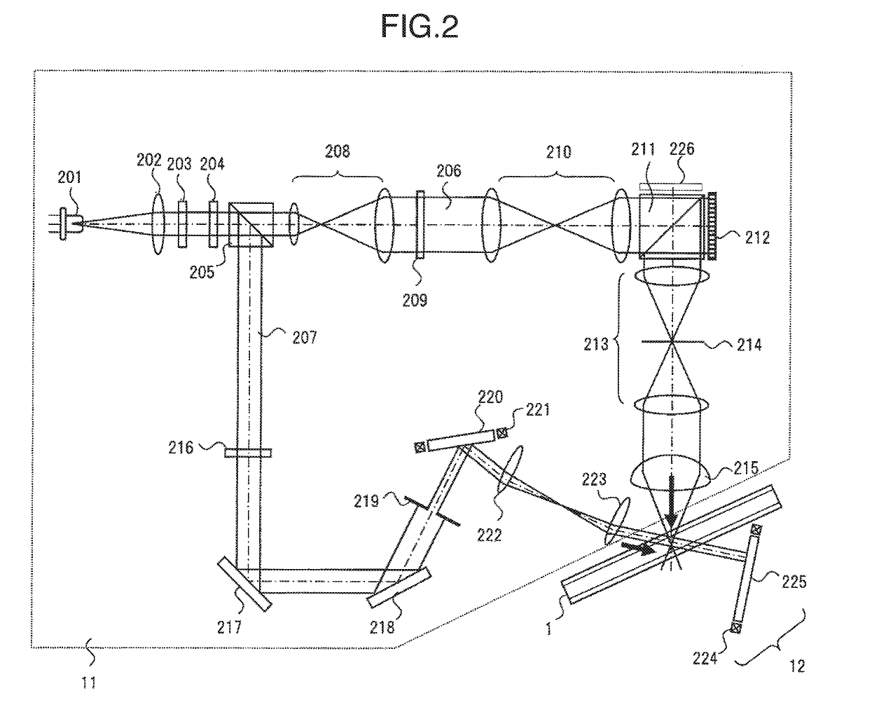

FIG. 2 illustrates a recording principle in an example of a basic optical system configuration of pickup 11 in optical information recording/reproduction device 10. A light beam emitted from light source 201 passes through collimating lens 202 and enters shutter 203. When shutter 203 is open, the light beam passes through shutter 203, and with a polarization direction thereof being controlled by optical element 204 composed of for example, a half-wavelength plate so that a light quantity ratio of p-polarization and s-polarization becomes a desired ratio, the light beam is made incident upon PBS (Polarization Beam Splitter) prism 205.

The light beam that has passed through PBS prism 205 functions as signal light 206 and with the light beam diameter enlarged by beam expander 208, passes through phase mask 209, relay lenses 210 and PBS prism 211 and enters spatial optical modulator 212.

Signal light to which information is added by spatial optical modulator 212, is reflected by PBS prism 211 and propagates through relay lenses 213 and spatial filter 214. Then, the signal light is condensed by objective lens 215 to optical information recording medium 1 as a spherical wave.

On the other hand, the light beam reflected by PBS prism 205 functions as reference light 207, is set to a predetermined polarization direction by polarization direction conversion element 216 during recording or reproduction, and enters galvanomirror 220 through mirror 217, mirror 218 and iris 219.

Here, iris 219 is an opening element that two-dimensionally limits the cross-sectional size of reference light 207. Therefore, the beam diameter of reference light 207 that has passed through iris 219 may be considered as being limited to a predetermined size. Moreover, the beam diameter of reference light 207 is determined by the size of the opening of iris 219.

Note that a beam expander may be used instead of the iris to limit the beam diameter of the reference light. In this case, the reference light may be caused to enter the beam expander from an opposite direction and the beam diameter of the reference light may be reduced. Using the beam expander instead of the iris allows a component of the reference light limited by the iris to be used to record holograms, and allows a recording operation in a shorter time.

Furthermore, since the angle of galvanomirror 220 can be adjusted by actuator 221, an angle of incidence of the reference light that enters optical information recording medium 1 as a planar wave after passing through lens 222 and lens 223 can be set to a desired angle. Note that in order to set the angle of incidence of the reference light, an element to convert the wave front of the reference light may be used instead of the galvanomirror.

Thus, by causing the signal light and the reference light to enter optical information recording medium 1 so as to overlap with each other, an interference fringe pattern is formed in the recording medium, and by writing the pattern into the recording medium, information is recorded. Moreover, galvanomirror 220 allows the angle of incidence of the reference light incident upon optical information recording medium 1 to be changed, which allows recording by angle multiplexing.

Hereinafter, in a hologram which is recorded by changing the angle of reference light in the same region, a hologram corresponding to one angle of reference light is called a “page” and a set of angle-multiplexed pages in the same region is called a “book.”

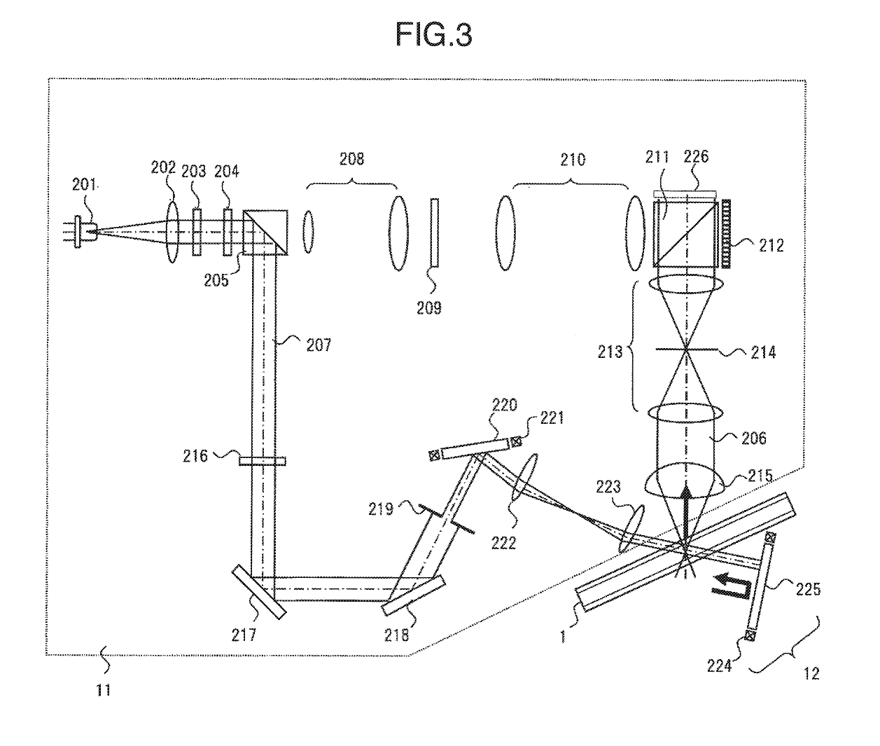

FIG. 3 illustrates a reproduction principle in an example of a basic optical system configuration of pickup 11 in optical information recording/reproduction device 10. When recorded information is reproduced, as described above, reference light for reproduction is generated by causing the reference light to enter optical information recording medium 1 and causing a light beam that has passed through optical information recording medium 1 to be reflected by galvanomirror 225 whose angle is adjustable by actuator 224.

The reproduced light reproduced by the reference light for reproduction propagates through objective lens 215, relay lenses 213 and spatial filter 214. After that, the reproduced light passes through PBS prism 211, enters photodetector 226, whereby it is possible to reproduce the recorded signal. As photodetector 226, an image pickup element such as a CMOS image sensor or a CCD image sensor can be used, but any element may also be used as long as such an element can reproduce page data.

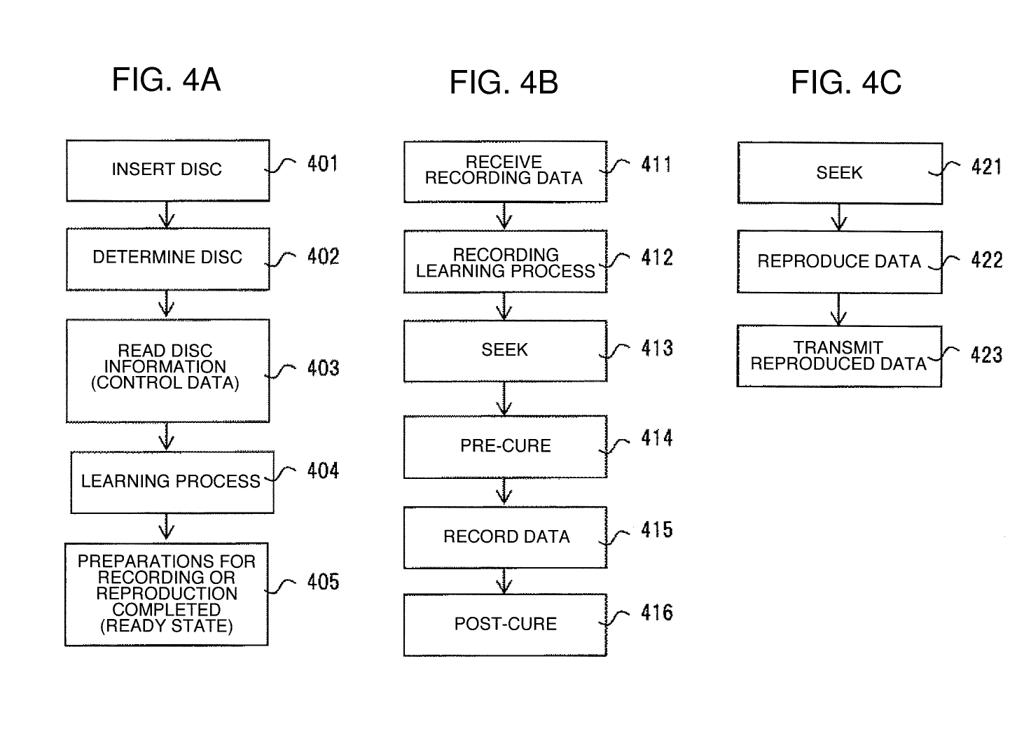

FIG. 4 illustrates an operation flow of recording and reproduction by optical information recording-reproduction device 10. Here, a flow will be described which relates to recording and reproduction using holography in particular.

FIG. 4(a) illustrates an operation flow after inserting optical information recording medium 1 into optical information recording/reproduction device 10 until a preparation for recording or reproduction is completed and FIG. 4(b) illustrates an operation flow from completion of the preparation until information is recorded on optical information recording medium 1 and FIG. 4(c) illustrates an operation flow from completion of the preparation until the information recorded in optical information recording medium 1 is reproduced.

As shown in FIG. 4(a), when a medium is inserted (401), optical information recording/reproduction device 10 judges, for example, the disc to determine whether or not the inserted medium is a medium that records or reproduces digital information using holography (402).

When the disc judgment result shows that the inserted medium is the optical information recording medium that records or reproduces digital information using holography optical information recording/reproduction device 10 reads control data provided in the optical information recording medium (403) and acquires, for example, information on the optical information recording medium or information on various setting conditions during recording or reproduction, for example.

After the control data is read, various adjustments corresponding to the control data and a learning process relevant to pickup 11 are performed (404), and optical information recording/reproduction device 10 completes the preparation for recording or reproduction (405).

In the operation flow from completion of the preparation until the information is recorded, data to be recorded is received first (411) and the information corresponding to the data is sent to the spatial optical modulator in pickup 11 as shown in FIG. 4(b).

After that, in order to record high quality information on the optical information recording medium, various types of recording leaning process such as power optimization of light source 201 and optimization of exposure times by shutter 203 are performed in advance as required (412).

Then, in a seek operation (413), pickup 11 and cure optical system 13 are located at predetermined positions of the optical information recording medium by controlling access control circuit 81. When optical information recording medium 1 has address information, the flow repeats operation of reproducing the address information, confirming whether or not optical information recording medium 1 is located at a desired position, and calculating, if optical information recording medium 1 is not located at the desired position, an amount of deviation from the predetermined position and relocating optical information recording medium 1.

After that, a predetermined region is pre-cured using a light beam emitted from cure optical system 13 (414), and data is recorded using the reference light and the signal light emitted from pickup 11 (415).

After the data is recorded, post-curing is performed using the light beam emitted from cure optical system 13 (416). The data may be verified as required.

In the operation flow from completion of the preparation until the recorded information is reproduced, by controlling access control circuit 81 in a seek operation first (421) as shown in FIG. 4(c), pickup 11 and reproduction reference light optical system 12 are located at predetermined positions of the optical information recording medium. When optical information recording medium 1 has address information, the flow repeats operation of reproducing the address information confirming whether or not optical information recording medium 1 is located at a desired position and calculating if optical information recording medium 1 is not located at the desired position, an amount of deviation from the desired position and relocating optical information recording medium 1.

After that, the reference light is emitted from pickup 11, information recorded in the optical information recording medium is read (422), and reproduced data is transmitted (423).

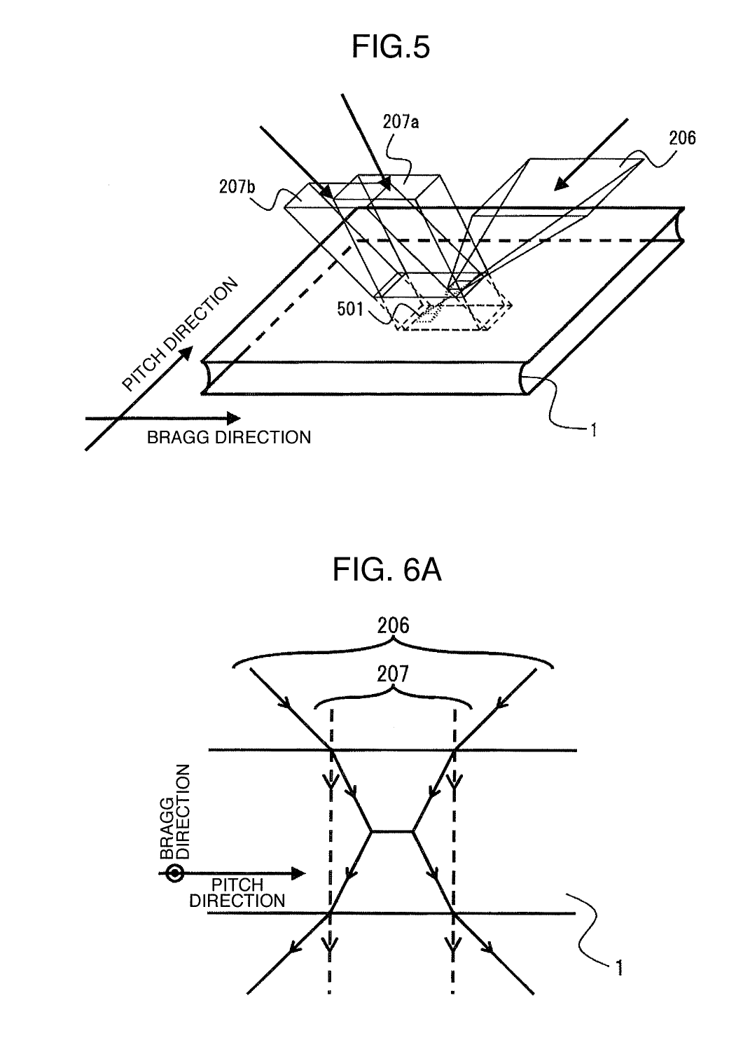

FIG. 5 illustrates a situation in which optical information recording medium 1 is irradiated with signal light 206 and reference light 207, and a plurality of angle-multiplexed pages are recorded. That is, FIG. 5 illustrates the situations of signal light 206, reference light 207 and optical information recording medium 1 during the processing of data recording 615 in FIG. 4.

An angle of incidence of reference light 207 with which optical information recording medium 1 is irradiated is successively changed in accordance with a page to be recorded. For example, the flow repeats operation of irradiating, when recording a first page, optical information recording medium 1 with signal light 206 and reference light 207a simultaneously, and irradiating, when recording a second page, optical information recording medium 1 with signal light 206 and reference light 207b simultaneously to thereby record a plurality of pages as one book 501. In the following description, in recording a plurality of multiplexed pages as one hologram a direction in which the angle of incidence of reference light is changed is called a “Bragg direction” and a direction orthogonal to the Bragg direction is called a “pitch direction.”

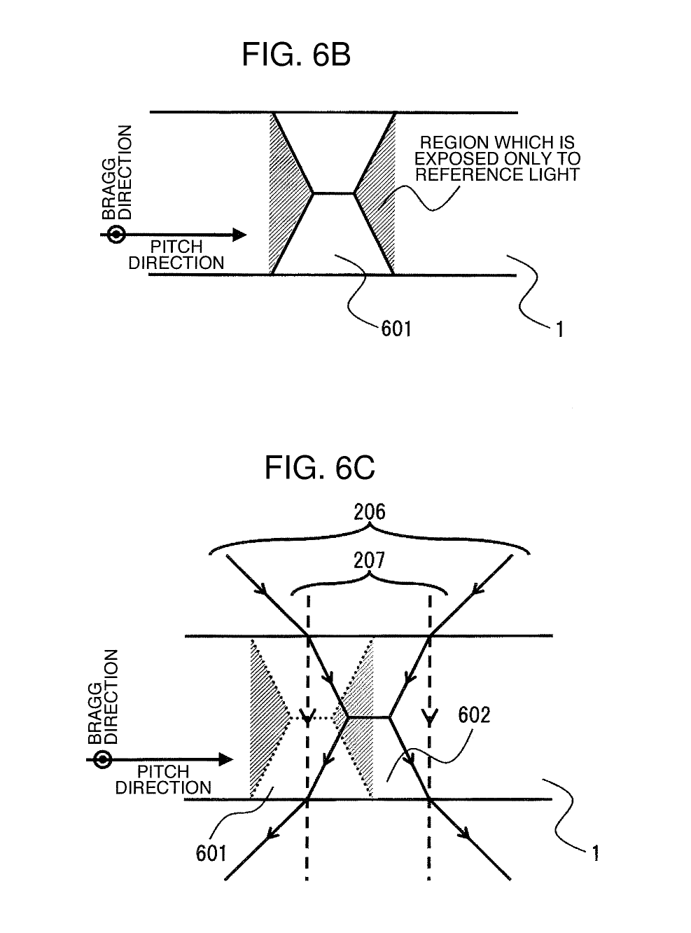

FIG. 6(a), FIG. 6(b) and FIG. 6(c) are cross-sectional views, seen from the Bragg direction, of optical information recording medium 1 according to the prior art, which is irradiated with signal light 206 and reference light 207 during page recording. In the prior art as shown in FIG. 6(a), in order to record a hologram with stable reproduction quality, optical information recording medium 1 is irradiated with signal light 206 and reference light 207 such that all signal light 206 that passes through optical information recording medium 1 overlaps with reference light 207.

In this case, as shown in FIG. 6(b), there exists in the recording region adjacent to book 601, a region which is exposed only to the reference light and no interference fringe is recorded. When the recording medium is irradiated with only the reference light, M/# of the recording material is wastefully consumed in the region, which results in a problem that the number of pages that can be multiplexed in the region reduces.

Here, as shown in FIG. 6(c), when the recording density is improved by reducing the distance between book 601 and book 602, book 602 needs to be recorded in a recording region where M/# is wastefully consumed during recording of book 601. For this reason, the recording region where book 602 is recorded cannot obtain M/# equivalent to that of book 601, resulting in a problem that the number of pages that can be multiplexed decreases, causing the recording density to decrease.

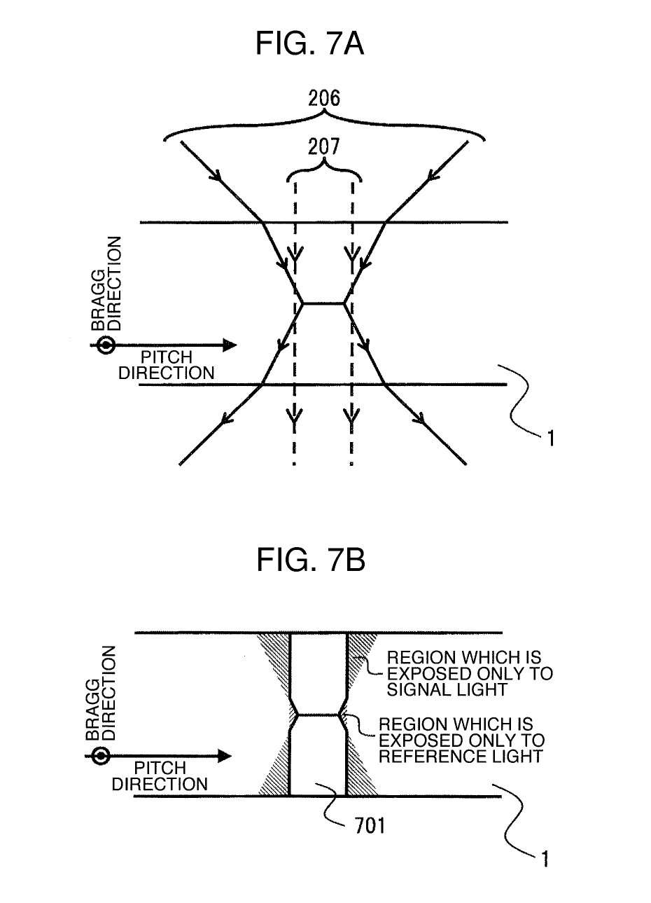

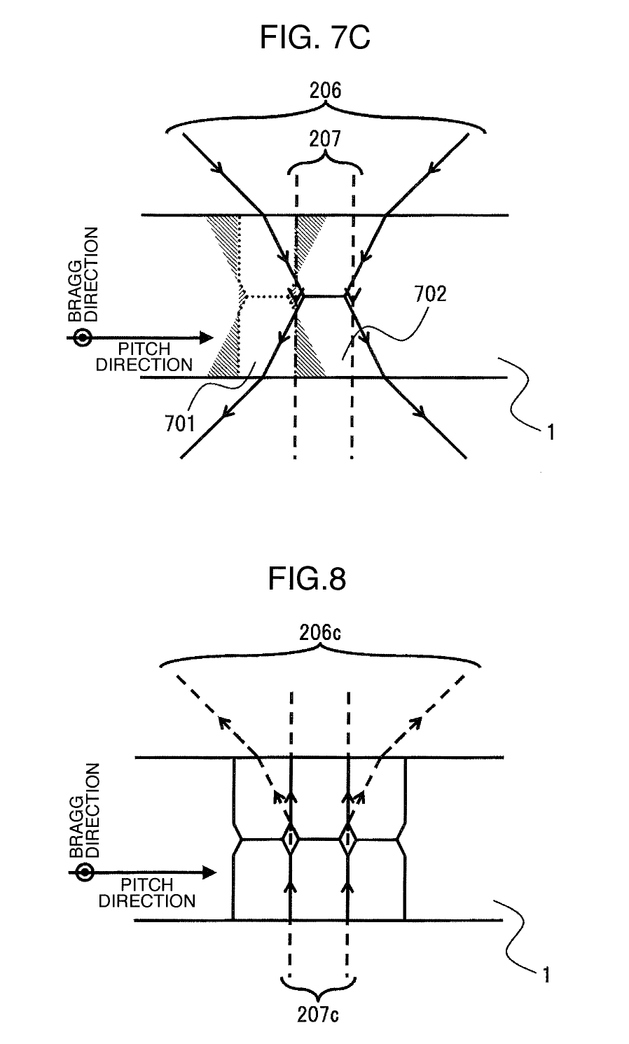

Thus, to solve the present problem, as shown in FIG. 7(a), FIG. 7(b) and FIG. 7(c), a method of recording holograms will be described whereby part of signal light 206 that passes through optical information recording medium 1 is left over.

FIG. 7(a), FIG. 7(b) and FIG. 7(c) are cross-sectional views, seen from a Bragg direction, of optical information recording medium 1 which is irradiated with signal light 206 and reference light 207 during page recording. According to the present recording method, as shown in FIG. 7(a), optical information recording medium 1 is irradiated with signal light 206 such that the beam waist of signal light 206 is located inside optical recording information medium 1, the beam diameter of reference light 207 in the pitch direction is changed to a predetermined value using iris 219 and part of signal light 206 that passes through optical information recording medium 1 is left over to record holograms. Note that hereinafter, the beam diameter or beam width will refer to a diameter or a width of a beam with which the recording surface of the optical information recording medium is irradiated.

When the present recording method is used, as shown in FIG. 7(b), there exists a region which is exposed only to the signal light and a region which is exposed only to the reference light in the recording region in the vicinity of book 701. However, the size of the region which is exposed only to the signal light or the reference light is smaller compared to FIG. 6(b) and the volume in which M/# of the recording medium is wastefully consumed is decreased compared to that under the conventional scheme.

In this condition, as shown in FIG. 7(c), when the recording density is improved by reducing the distance between book 701 and book 702, M/# of the recording medium that can be used for recording of the multiplexed pages in the recording region of book 702 is greater than in the case in FIG. 6(c) and the number of holograms that can be multiplexed increases. Furthermore, as the number of holograms that can be multiplexed increases, the number of pages that make up each book increases, resulting in an effect of improving the recording density. Note that when a cross section of optical information recording medium 1 is seen from the Bragg direction, FIG. 7(c) shows a situation in which book 702 is recorded at a distance at which book 701 and book 702 do not overlap each other, bit to further improve the recording density, the book may be recorded at a distance at which book 701 and book 702 overlap each other.

FIG. 7(a), FIG. 7(b) and FIG. 7(c) illustrate an example where the recording interval of respective books is set to a distance at which beam waists of signal light 206 do not overlap each other when seen from the thickness direction of the optical information recording medium, but the recording density can be improved even when holograms are recorded at a recording interval at which beam waists of neighboring holograms overlap each other.

Note that the beam width of reference light 207 with which optical information recording medium 1 is irradiated is preferably greater than the width of the beam waist of signal light 206 as shown in FIGS. 7(a) to (c). This is because if the beam diameter of the reference light in the pitch direction is a beam diameter which is smaller than the width of the beam waist of signal light 206, only part of the spatial frequency component of a signal light image is recorded and it is not possible to record holograms with stable reproduction quality.

FIG. 8 illustrates a situation in which optical information recording medium 1 is irradiated with reference light 207c and signal light 206c is reproduced from a hologram recorded using the recording method in FIG. 7. That is, FIG. 8 illustrates a situation of reference light 207, optical information recording medium 1 and reproduced signal light 206 while data reproduction 422 in FIG. 4 is in progress. As described in FIG. 3 above, the reference light with which optical information recording medium 1 is irradiated during reproduction is reflected by mirror 225 and optical information recording medium 1 is irradiated with the reference light in a direction opposite to the direction during recording. Reproduced signal light 206c reversely propagates through the optical element through which signal light 206c passes during recording and reaches photodetector 226.

Using the above-described method makes it possible to suppress wasteful consumption of M/# of the recording material and realize recording at a shorter interval of respective books, and thereby achieve high density recording.

Note that although the present embodiment has shown an example where optical information recording medium 1 is irradiated with signal light 206 such that the beam waist of signal light 206 is located inside optical information recording medium 1, even when optical information recording medium 1 is irradiated with signal light 206 such that the beam waist of signal light 206 is located outside optical information recording medium 1, it is possible to suppress wasteful consumption of M/# of the recording material and achieve an effect of realizing recording at a reduced interval of respective books as in the case of the present embodiment.

### Embodiment 2

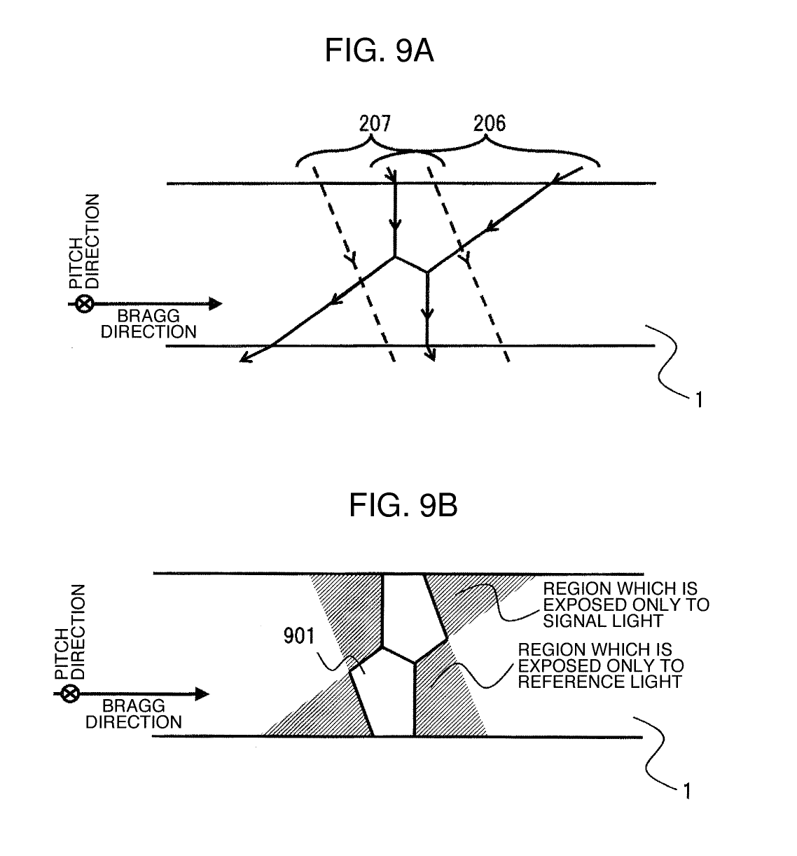

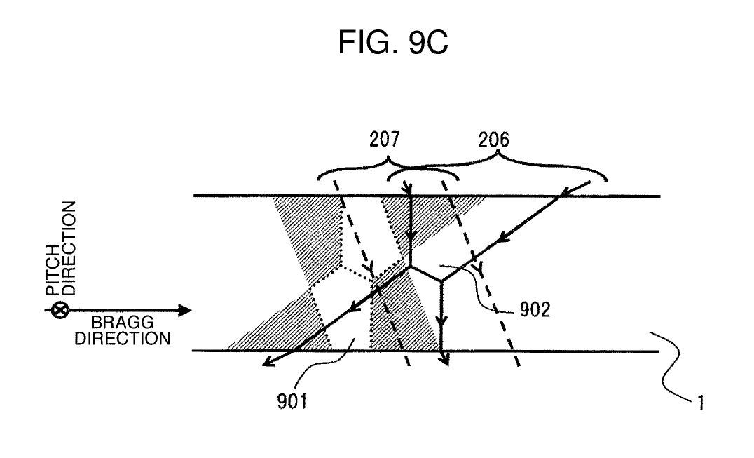

The present embodiment describes a case where the beam diameter of reference light in the Bragg direction is changed. Note that the configuration except the direction in which the beam diameter of the reference light is changed is similar to that of Embodiment 1, and therefore description thereof will be omitted. FIG. 9(a), FIG. 9(b) and FIG. 9(c) show cross-sectional views, seen from the pitch direction, of optical information recording medium 1 which is irradiated with signal light 206 and reference light 207 during page recording and the beam diameter of the reference light is changed compared to the conventional scheme in order to reduce wasteful consumption of M/# of the recording medium.

In the present embodiment, as shown in FIG. 9(a), the beam diameter of reference light 207 in the Bragg direction is changed to a predetermined value using iris 219 and books are recorded by causing part of signal light 206 passing through optical information recording medium 1 to be left over. When the present recording method is used, as shown in FIG. 9(b), there exists a region which is exposed only to signal light and a region which is exposed only to reference light in a recording region in the vicinity of book 901.

However, the size of the region which is exposed only to the signal light or the reference light is smaller than that under the conventional scheme whereby optical information recording medium 1 is irradiated with reference light so as to include all the signal light to record books, which suppresses wasteful consumption of M/# of the recording medium.

In this case, when the distance between book 901 and book 902 is reduced to improve the recording density as shown in FIG. 9(c), M/# of the recording medium which can be used in the recording region of book 902 increases compared to the conventional scheme whereby optical information recording medium 1 is irradiated with reference light so as to include all the signal light, thus making it possible to improve the recording density with an increase in the number of holograms that can be multiplexed.

Using the above-described method can further improve the recording density compared to Embodiment 1 in that wasteful consumption of M/# of the recording medium is suppressed not only in the pitch direction bit also in the Bragg direction in the recording region in the vicinity of books.

### Embodiment 3

The present embodiment describes a case where the beam diameter of reference light in the Bragg direction is made variable in accordance with the angle of reference light. Note that since the configuration except the location in which the size of the opening of the iris is variable is similar to that of Embodiment 2, description thereof will be omitted.

When the aforementioned method of Embodiment 2 is used, if angle-multiplexed pages are recorded by changing the beam diameter of reference light in the Bragg direction, the problem is that the beam diameter of reference light with which the medium is irradiated changes in accordance with the angle of reference light. Thus, by changing the beam diameter of reference light in accordance with the angle of reference light, it is possible to keep constant the beam diameter of reference light contributing to recording of holograms even when the angle of reference light changes.

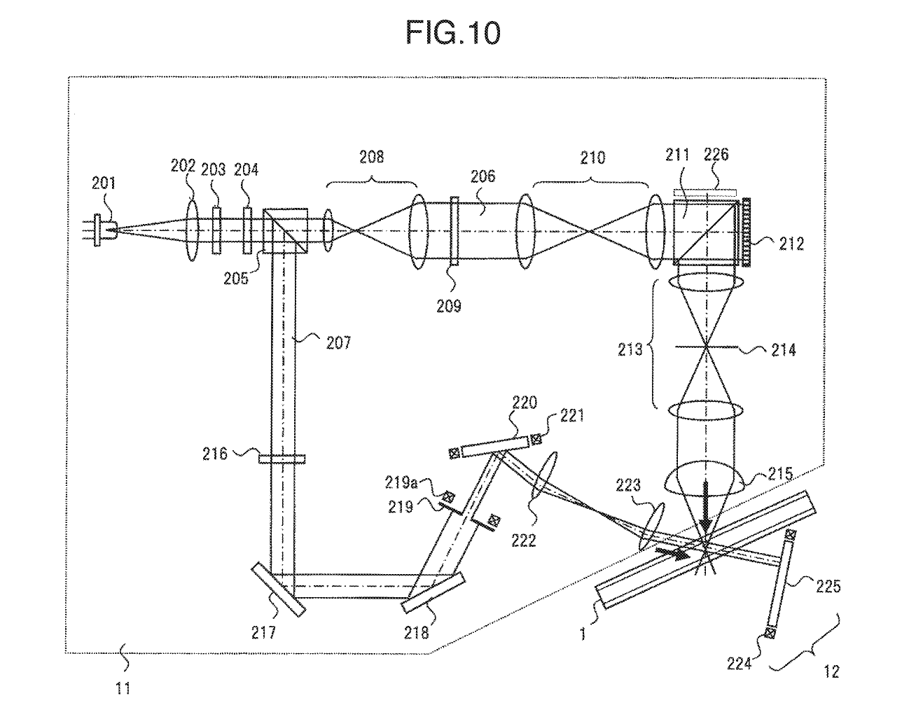

FIG. 10 illustrates another mode of FIG. 2 in which iris actuator 219a that controls the opening size of iris 219 is added. Iris actuator 219a controls the opening size of iris 219 in accordance with the angle of reference light when pages are recorded. Note that when pages are reproduced, iris actuator 219a sets the opening size of iris 219 to a predetermined value regardless of the angle of reference light.

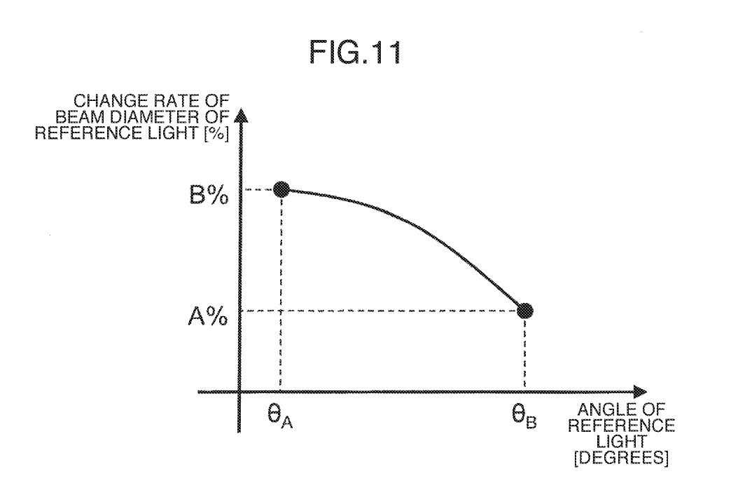

FIG. 11 illustrates an example of a relationship between an angle of reference light for recording a page and an optimum change rate of a beam diameter of reference light. In this way, if the change rate of the beam diameter of reference light is changed in accordance with the angle of reference light using iris 219 and iris actuator 219a, it is possible to suppress wasteful consumption of M/# of the recording region in the vicinity of a book even when the angle of reference light changes due to recording of angle-multiplexed pages.

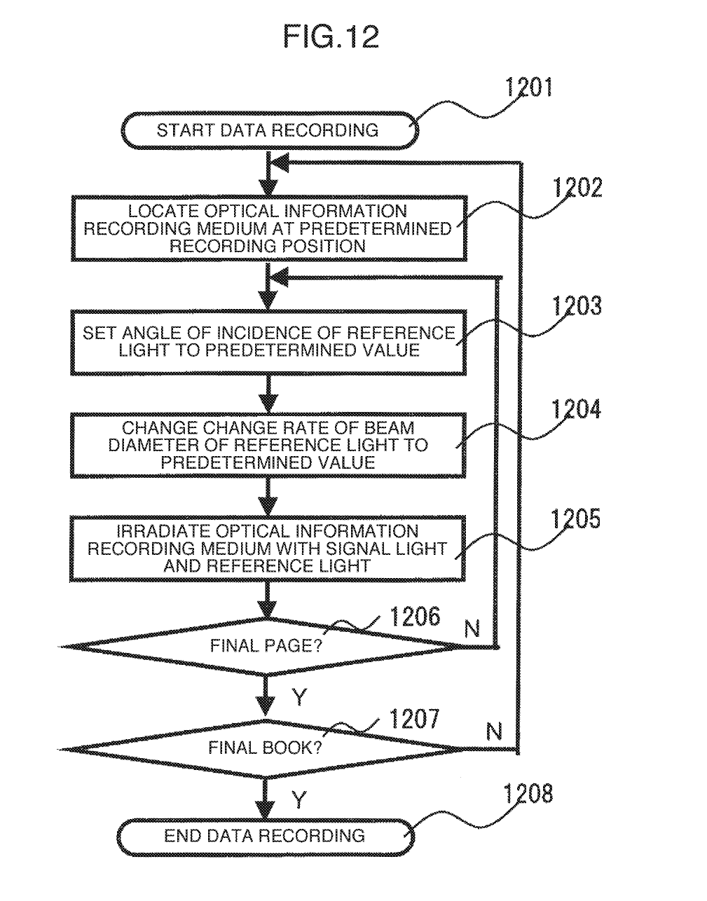

FIG. 12 is a flowchart of successively recording pages while changing the change rate of the beam diameter of reference light in accordance with the angle of incidence of reference light. That is, FIG. 12 describes details of data recording process 415.

First, when data recording starts (1201), the optical information recording medium is located at a predetermined recording position (1202), and then the angle of incidence of reference light is set to an angle of incidence for recording a first page (1203).

After that, the opening size of iris 219 is controlled by iris actuator 219a to obtain the change rate of the beam diameter of reference light corresponding to the angle of incidence of reference light set in step 1203 (1204). Optical information recording medium 1 is irradiated with signal light 206 and reference light 207 set to the change rate of the beam diameter of reference light of a predetermined value (1205) and pages are recorded.

Hereinafter, the flow repeats similar processes while changing the angle of reference light for recording pages until recording of all pages making up a book is completed (1206) and repeats similar processes while changing a recording position of a book with respect to the optical information recording medium until recording of all books making up data is completed (1207). When recording of all the books making up the data is completed, the data recording process ends (1208).

Using the above-described method can keep constant the beam diameter of reference light contributing to recording of holograms even when the angle of reference light changes, and therefore the above-described method excels the method described in Embodiment 2 in that it is possible to record holograms with stable reproduction quality.

### Embodiment 4

The present embodiment describes a case where the beam diameter of reference light in the Bragg direction is gradually changed in accordance with the angle of reference light and books are recorded in combination with a prior art called “short stack.” Note that the configuration except a location at which the opening size of iris 219 is gradually controlled and a location at which the present embodiment is combined with a short stack is similar to that of Embodiment 3, and therefore description thereof will be omitted.

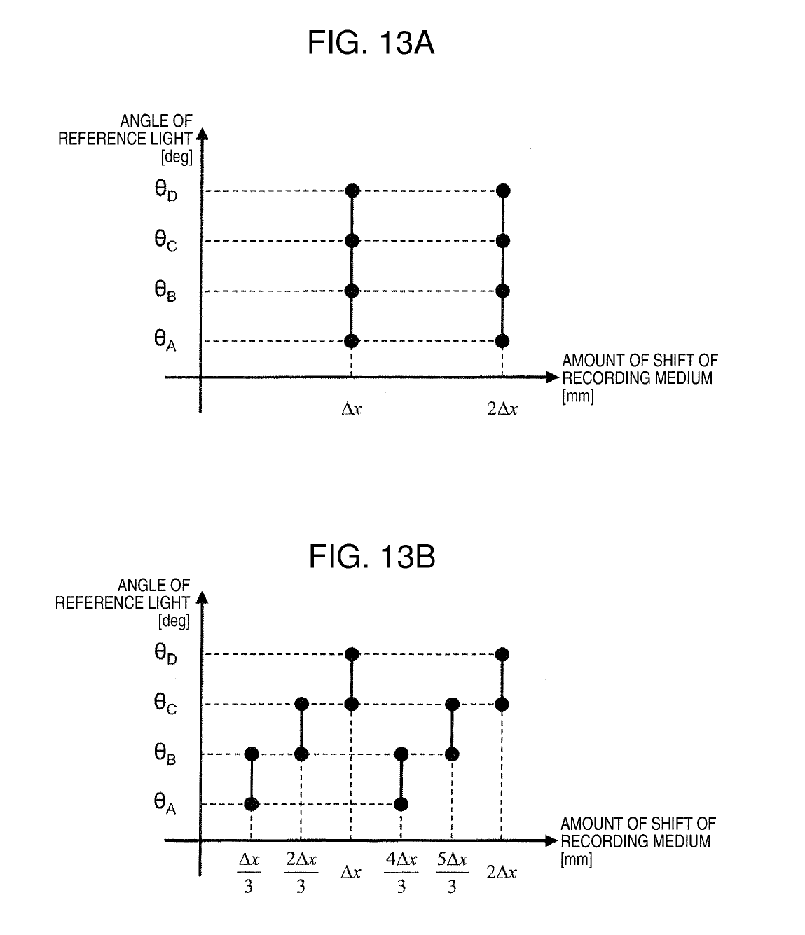

FIG. 13(a) and FIG. 13(b) illustrate a relationship between an amount of shift of a recording medium and a reference light angle range used for page recording when a plurality of books are arranged on the recording medium and recorded. Conventionally, when a plurality of books are recorded assuming that an interval of respective books is Δx as shown in FIG. 13(a), pages are recorded within a range of the angle of reference light of θA to θD while shifting the recording medium by Δx.

However, when many angle-multiplexed pages are recorded at the same location of a recording medium, the amount of consumption of M/# of the recording medium in the recording region increases, resulting in a problem that intensity of reproduced light of each page decreases.

This, as shown in FIG. 13(b), when the reference light angle range for recording pages is divided into three sections of θA to θB, θB to θC and θC to θD and a book is recorded by shifting the recording medium by Δx/3, the amount of consumption of M/# in the recording region is reduced, consequently making it possible to obtain greater intensity of reproduced light compared to FIG. 13(a). This technique is called a “short stack” and is disclosed in JP-A-2010-508617 or the like.

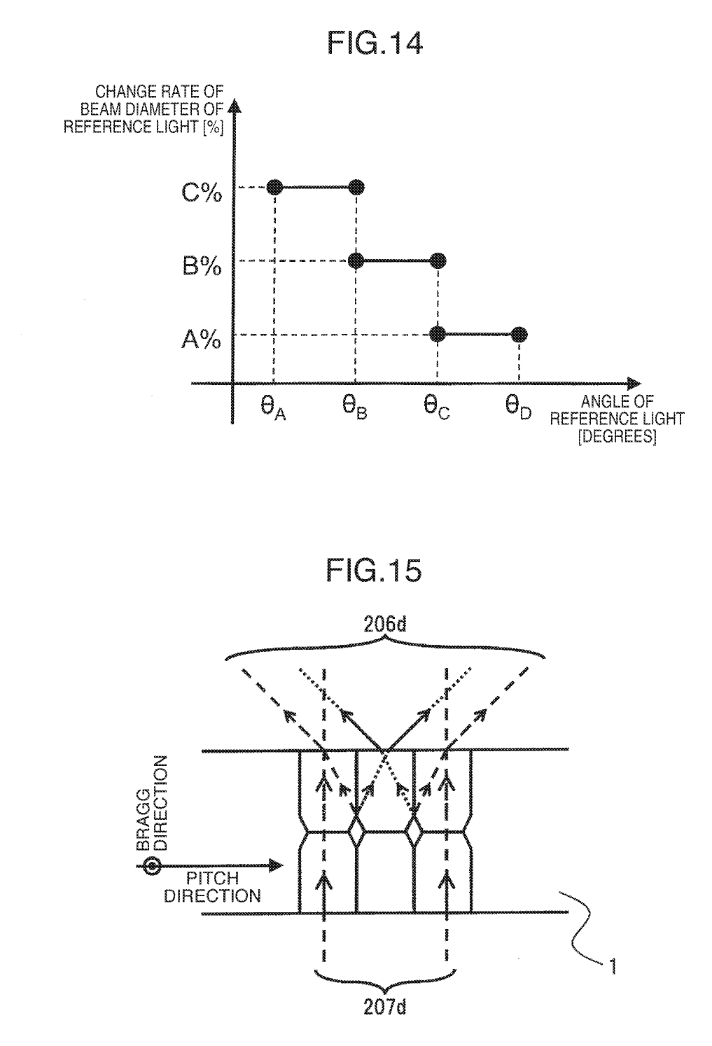

When the above-described short stack is used in combination with the recording method described in Embodiment 3, for example, the change rate of the beam diameter of reference light may be set as shown in FIG. 14. Here, since the reference light angle range for recording pages is divided into three sections of θA to θB, θB to θC and θC to θD, each section is given a uniform change rate of the beam diameter of reference light.

The present method excels the method in Embodiment 3 which adaptively changes the change rate of the beam diameter of reference light in accordance with the angle of reference light, in that control of iris actuator 219a can be simplified and the amount of consumption of M/# of the recording medium is reduced by dividing the amount of shift of the recording medium.

### Embodiment 5

The present embodiment describes a case where reproduction operation is performed during book reproduction by increasing the beam diameter of reference light compared to the beam diameter during recording. Note that since the configuration except a location at which the opening size of iris 219 during reproduction is controlled to a greater size than that during recording is similar to that of Embodiment 3, description thereof will be omitted.

FIG. 15 shows another mode of FIG. 8. FIG. 15 illustrates a situation in which reference light 207d having a beam diameter different from that during recording is radiated to reproduce signal light 206d. The beam diameter of reference light 207d is increased compared to reference light 207c having the same beam diameter as that during recording. As the method of increasing the beam diameter of reference light only during reproduction, iris actuator 219a is controlled during reproduction.

Furthermore, in order to increase the beam diameter of the reference light, a beam expander may be used instead of the iris. In this case, reference light may be caused to enter the beam expander in a forward direction to increase the beam diameter of reference light.

Here, when a book is reproduced using reference light 207d whose beam diameter is increased during reproduction, there is a problem that in addition to the book to be reproduced, signal light of the adjacent book is also simultaneously reproduced. However, since the signal light from the adjacent book is removed by spatial filter 214, only desired signal light reaches photodetector 226.

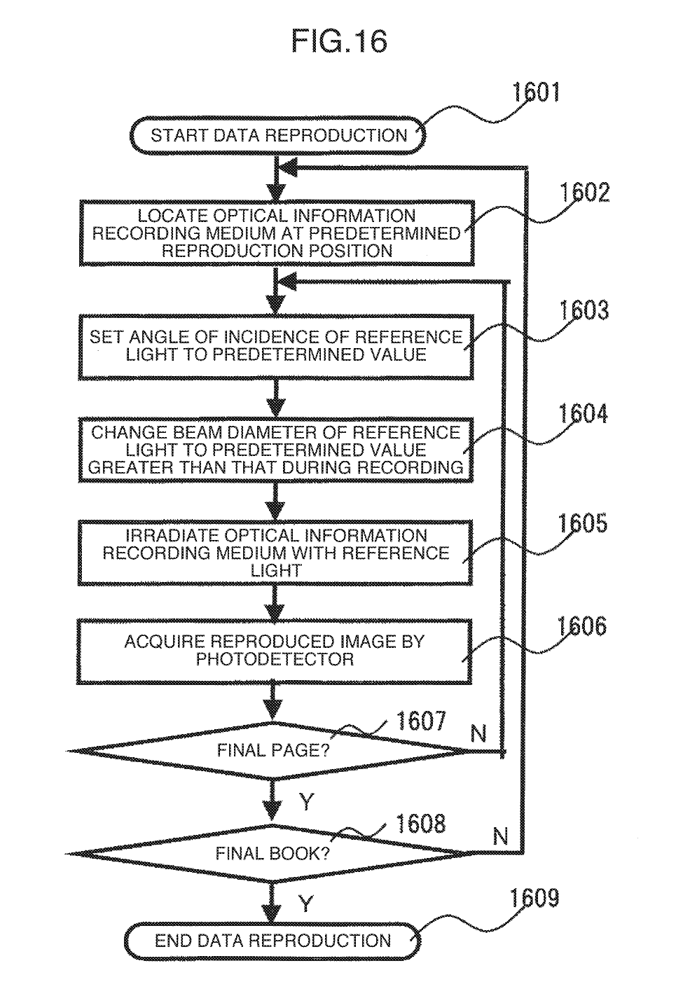

FIG. 16 illustrates a flowchart of reproduction operation carried out during reproduction in which the opening size of iris 219 is increased by iris actuator 219a. That is, FIG. 16 describes details of data reproduction process 422.

First, when data reproduction starts (1601), an optical information recording medium is located at a predetermined reproduction position (1602), and then an angle of incidence of reference light is set to an angle of incidence to reproduce a first page (1603).

After that, iris actuator 219a controls the opening size of iris 219 so that the beam diameter of reference light has a predetermined value greater than that during recording (1604). Optical information recording medium 1 is irradiated with reference light 207 set to the beam diameter of the predetermined value (1605), a page is reproduced and a reproduced image of the page is acquired by a photodetector in 1606.

Hereinafter, the flow repeats similar processes while changing the angle of reference light for reproducing pages until reproductions of all pages making up a book are completed (1607), and further repeats similar processes while changing the reproduction position of the book with respect to the optical information recording medium until reproductions of all books making up data are completed (1608). When reproductions of all books making up the data are completed, the data reproduction process is completed (1609).

The above-described method excels the method described in FIG. 8 in that signal light is obtained when reproduction operation is performed by expanding reference light during reproduction even when optical information recording medium 1 is dislocated during reproduction.

### Embodiment 6

The present embodiment describes a case where the beam diameter of reference light is optimally controlled to perform reproduction operation during book reproduction. Note that since the configuration except a location where the opening size of iris 219 during reproduction is controlled to an optimum size for reproduction of signal light is similar to that in Embodiment 5, description thereof will be omitted.

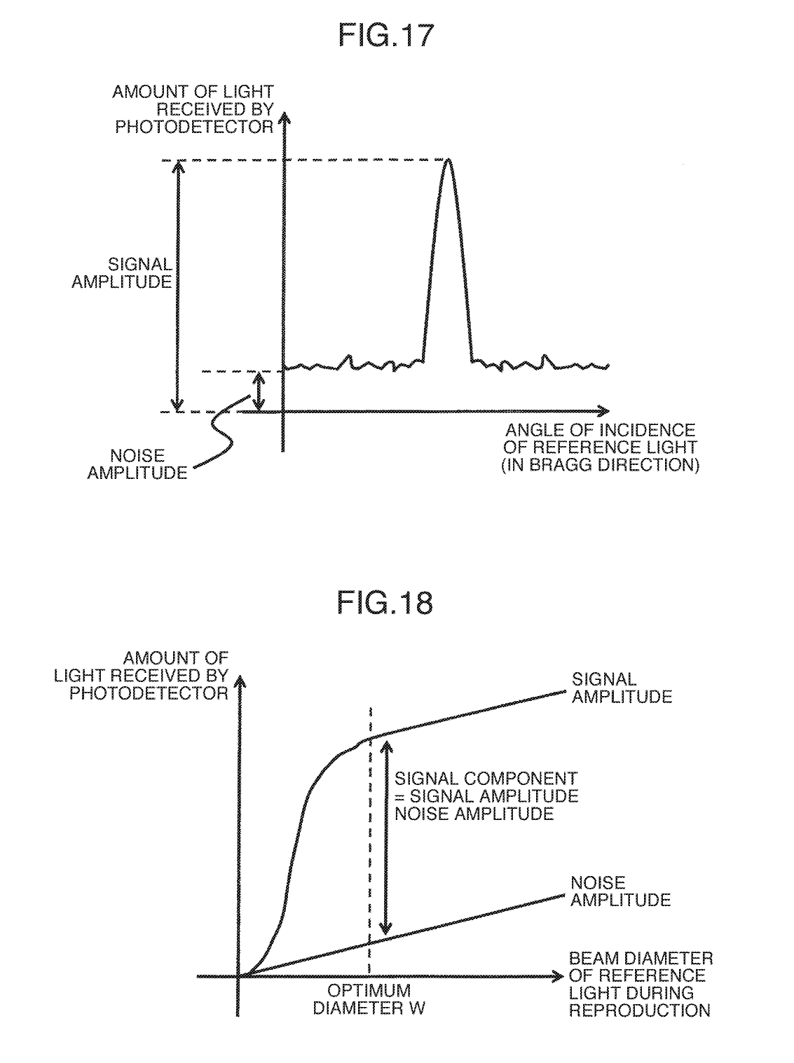

Focusing on one specific page in a book, FIG. 17 illustrates a relationship between an angle of incidence of reference light and an amount of light received by a photodetector when a page is reproduced while changing the angle of incidence of reference light with respect to the optical information recording medium. The amount of light received by the photodetector takes a maximum value when the angle of incidence of reference light is optimum and gradually decreases as the amount of deviation of the angle of incidence of reference light increases. Here, the maximum value of the amount of light received by the photodetector is defined as “signal amplitude” and the minimum value is defined as “noise amplitude.”

FIG. 18 illustrates a relationship between signal amplitude and noise amplitude when the beam diameter of reference light is changed during reproduction. The signal component here is defined as a value obtained by subtracting noise amplitude from signal amplitude.

When the beam diameter of reference light during reproduction is increased, the noise amplitude increases in proportion to the beam diameter of reference light, whereas an increase in the signal component obtained by subtracting the noise amplitude from the signal amplitude is saturated at a predetermined value of the beam diameter of reference light. This saturation is caused when the beam diameter of reference light is increased and the beam diameter of reference light eventually exceeds the size of a hologram to be recorded.

Furthermore, since noise amplitude is caused by leakage of in-plane reflected light of the optical information recording medium into the photodetector, it is preferable to perform reproduction by minimizing the reflected light which is a principal factor of noise.

Therefore, the beam diameter of reference light during reproduction includes optimum diameter W corresponding to a maximum signal component. Furthermore, the magnitude of noise amplitude changes depending on the angle of incidence of reference light, and it is therefore preferable to control the beam diameter of reference light so as to reach optimum diameter W in accordance with the angle of incidence of reference light.

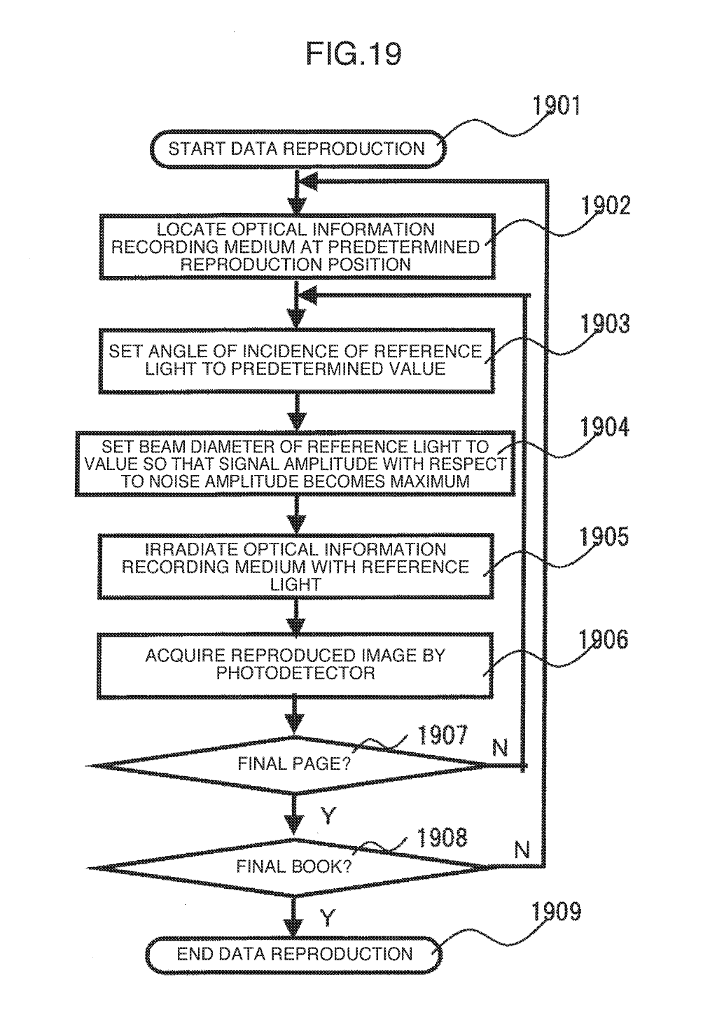

FIG. 19 illustrates a flowchart of reproduction operation that optimally controls the size of the beam diameter of reference light in accordance with the angle of incidence of reference light during reproduction. That is, FIG. 19 describes details of data reproduction process 422.

First, when data reproduction starts (1901), the optical information recording medium is located at a predetermined reproduction position (1902), and then the angle of incidence of reference light is set to an angle of incidence for reproducing a first page (1903).

After that, iris actuator 219a controls the opening size of iris 219 so that the beam diameter of reference light corresponds to maximum signal amplitude with respect to the noise amplitude on the photodetector (1904). Optical information recording medium 1 is irradiated with reference light 207 set to an optimum beam diameter during signal reproduction (1905), a page is reproduced and a reproduced image of the page is acquired by a photodetector in 1906.

Hereinafter, the flow repeats processes from 1902 to 1906 while changing the angle of reference light for reproducing pages until reproductions of all pages making up a book are completed (1907) and further repeats processes from 1902 to 1907 while changing the reproduction positions of books with respect to the optical information recording medium until reproductions of all books making up data are completed (1908). When reproductions of all books making up the data are completed, the data reproduction process is completed (1909).

When reproduction operation is performed using the above-described method, it is possible to minimize influences of noise amplitude on signal amplitude and perform reproduction operation with higher signal quality, and therefore the present method excels the method described in Embodiment 5.

Note that the present invention is not limited to the above-described embodiments, but the present invention includes various modifications. For example, the above-described embodiments have been described in detail to describe the present invention in a way that is easy to understand, but the present invention is not necessarily limited to those including all the components described above. Components of another embodiment may be added to components of one embodiment. Other components my be added, deleted or substituted to/from/for components of each embodiment.

Some or all of the above-described components may be configured by hardware or configured to be implemented by a processor executing a program. Control lines or information lines which are considered necessary for description have been described but not all control lines or information lines in the product are necessarily described. In reality, almost all components are deemed to be mutually connected.

### REFERENCE SIGNS LIST

1 . . . optical information recording medium 10 . . . optical information recording/reproduction device, 11 . . . pickup, 12 . . . reproduction reference light optical system, 13 . . . cure optical system 14 . . . disc rotation angle detection optical system 50 . . . rotary motor, 81 . . . access control circuit, 82 . . . light source drive circuit, 84 . . . servo control circuit, 85 . . . signal processing circuit, 86 . . . signal generation circuit, 87 . . . shutter control circuit, 88 . . . disc rotary motor control circuit, 89 . . . controller, 90 . . . input/output control circuit, 201 . . . light source, 202 . . . collimating lens, 203 . . . shutter. 204 . . . optical element, 205 . . . prism, 206 . . . signal light, 207 . . . reference light, 208 . . . beam expander, 209 . . . phase mask, 210 . . . relay lens, 211 . . . PBS prism 212 . . . spatial optical modulator, 213 . . . relay lens, 214 . . . spatial filter, 215 . . . objective lens. 216 . . . polarization direction conversion element, 217, 218 . . . mirror, 219 . . . iris, 219a . . . iris actuator, 220 . . . galvanomirror, 221 . . . actuator, 222, 223 . . . lens, 224 . . . actuator. 225 . . . galvanomirror, 226 . . . photodetector, 501, 601, 602, 701, 702, 901, 902 . . . book

1. An optical information recording device that records information on an optical information recording medium using interference between signal light and reference light, the optical information recording device comprising:
a light source that emits light toward the optical information recording medium;
a beam-splitting element that splits the emission light emitted from the light source into the signal light and the reference light;
a reference light angle control unit that controls an angle of incidence of the reference light with respect to the optical information recording medium;
a signal light optical system that irradiates the optical information recording medium with the signal light as a spherical wave; and
a reference light optical system that irradiates the optical information recording medium with the reference light as a planar wave,
wherein information is recorded by irradiating the optical information recording medium with the signal light and the reference light such that when the optical information recording medium is seen from a first direction which is a direction in which the angle of incidence of the reference light changes with respect to the optical information recording medium, there exist in the interior of the optical information recording medium a region which is exposed to the signal light, a region which is exposed to the reference light, and a region which is exposed to overlapping signal light and reference light.

2. The optical information recording device according to claim 1, wherein when the optical information recording medium is seen from the first direction, a width of a luminous flux of the reference light with which a recording surface of the optical information recording medium is irradiated is smaller than a width of a luminous flux of the signal light on the surface of the optical information recording medium and greater than a width of a beam waist of the signal light.

3. The optical information recording device according to claim 1, wherein the optical information recording medium is irradiated with the signal light such that the beam waist of the signal light is located inside the optical information recording medium.

4. The optical information recording device according to claim 1, further comprising an optical element upon which the reference light split by the beam-splitting element is incident,
wherein the optical information recording medium is irradiated with the reference light, a diameter of a luminous flux of which is reduced by the optical element.

5. The optical information recording device according to claim 1, wherein when the optical information recording medium is seen from the first direction, the region which is exposed to the overlapping signal light and reference light is located sandwiched between the regions which are exposed to the signal light.

6. The optical information recording device according to claim 1, wherein when the optical information recording medium is seen from a second direction which is orthogonal to the first direction, the region which is exposed to the overlapping signal light and reference light is located sandwiched between the regions which are exposed to the signal light.

7. The optical information recording device according to claim 6, wherein the optical information recording device comprises a reference light luminous flux diameter control unit that controls the width of the luminous flux of the reference light, and
the reference light luminous flux diameter control unit changes the width of the luminous flux of the reference light in accordance with the angle of incidence of the reference light.

8. The optical information recording device according to claim 6, wherein a size the luminous flux diameter of the reference light is changed in accordance with the angle of incidence of the reference light.

9. The optical information recording device according to claim 7, wherein a size the luminous flux diameter of the reference light is gradually changed in accordance with the angle of incidence of the reference light.

10. The optical information recording device according to claim 1, wherein a first hologram generated by causing the signal light and the reference light to interfere with each other is generated such that the first hologram overlaps with part of a second hologram which is different from the first hologram.

11. An information recording method for recording information on an optical information recording medium using interference between signal light and reference light, the method comprising:
a step of emitting light toward the optical information recording medium;
a step of splitting the emission light emitted from the light source into the signal light and the reference light;
a step of controlling an angle of incidence of the reference light with respect to the optical information recording medium;
a step of irradiating the optical information recording medium with the signal light as a spherical wave;
a step of irradiating the optical information recording medium with the reference light as a planar wave; and
a step of recording information by irradiating the optical information recording medium with the signal light and the reference light such that when the optical information recording medium is seen from a first direction which is a direction in which the angle of incidence of the reference light changes with respect to the optical information recording medium, there exist in the interior of the optical information recording medium a region which is exposed to the signal light, a region which is exposed to the reference light, and a region which is exposed to overlapping signal light and reference light.

12. An information recording method for recording information on an optical information recording medium using interference between signal light and reference light, the method comprising:
a step of emitting light toward the optical information recording medium;
a step of splitting the emission light emitted from the light source into the signal light and the reference light;
a step of controlling an angle of incidence of the reference light with respect to the optical information recording medium;
a step of irradiating the optical information recording medium with the signal light as a spherical wave; and
a step of irradiating the optical information recording medium with the reference light as a planar wave,
wherein in the step of irradiating the optical information recording medium with the reference light, the optical information recording medium is irradiated with the reference light such that when the optical information recording medium is seen from a first direction which is a direction in which the angle of incidence of the reference light changes with respect to the optical information recording medium, a width of a luminous flux of the reference light with which a recording surface of the optical information recording medium is irradiated is smaller than a width of a luminous flux of the signal light on the surface of the optical information recording medium and greater than a width of a beam waist of the signal light.

13. The information recording method according to claim 11, wherein the optical information recording medium is irradiated with the signal light such that the beam waist of the signal light is located inside the optical information recording medium.

14. The information recording method according to claim 11, wherein in the step of recording the information, the optical information recording medium is irradiated with the signal light and the reference light when the optical information recording medium is seen from the first direction, a region which is exposed to the overlapping signal light and reference light is located sandwiched between the regions which are exposed to the signal light.

15. The information recording method according to claim 11, wherein in the step of recording the information, the optical information recording medium is irradiated with the signal light and the reference light when the optical information recording medium is seen from a second direction which is orthogonal to the first direction, a region which is exposed to the overlapping signal light and reference light is located sandwiched between the regions which are exposed to the signal light.

16. The information recording method according to claim 11, wherein the information recording/reproduction method comprises a step of changing a width of a luminous flux of the reference light, and
in the step of changing the width of the luminous flux of the reference light, a magnitude of the luminous flux of the reference light is changed in accordance with the angle of incidence of the reference light.

17. The information recording method according to claim 11, wherein the information recording/reproduction method comprises a step of changing the magnitude of the luminous flux of the reference light, and
in the step of changing a diameter of the luminous flux of the reference light, the width of the luminous flux of the reference light is changed in accordance with the angle of incidence of the reference light.

18. The information recording method according to claim 16, wherein in the step of changing the width of the luminous flux of the reference light, the width of the luminous flux of the reference light is gradually changed in accordance with the angle of incidence of the reference light.

19. The information recording method according to claim 11, wherein a first hologram generated by causing the signal light and the reference light to interfere with each other is generated such that the first hologram overlaps with part of a second hologram which is different from the first hologram.

20. The optical information recording device according to claim 2, wherein the optical information recording medium is irradiated with the signal light such that the beam waist of the signal light is located inside the optical information recording medium.
